(19) United States
(12) Patent Application Publication
(10) Pub. No.: US 2013/0250606 A1
(43) Pub. Date: Sep. 26, 2013

(54) BACKLIGHT MODULE AND LIQUID CRYSTAL DISPLAY

(71) Applicants: Gang Yu, Shenzhen (CN); Kuojun Fang, Shenzhen (CN)

(72) Inventors: Gang Yu, Shenzhen (CN); Kuojun Fang, Shenzhen (CN)

(73) Assignee: SHENZHEN CHINA STAR OPTOELECTRONICS TECHNOLOGY CO., LTD., Shenzhen (CN)

(21) Appl. No.: 13/574,468

(22) PCT Filed: Mar. 29, 2012
(86) PCT No.: PCT/CN2012/073223

§ 371 Date: Jul. 20, 2012

(30) Foreign Application Priority Data
Mar. 26, 2012 (CN) 201210082395.5

(51) Int. Cl. F21V 8/00

(52) U.S. Cl. 362/602; 362/619

(57) ABSTRACT

The present invention discloses a backlight module and a liquid crystal display (LCD). A light out surface of a light guide plate is provided with a plurality of micro structures. Each of the micro structures comprises a first light out surface and a second light out surface which are along the longitude direction and correspondingly been the inclined plane to each other. Besides, along a light in direction, at least one of the first oblique angle and the second oblique angle is changed with the increasing of distance from the light source, so that the lights can be uniformly emitted out through the micro structures.

### FIELD OF THE INVENTION

The present invention relates to a field of liquid crystal display technology, and more particularly to a backlight module and a liquid crystal display (LCD).

### BACKGROUND OF THE INVENTION

With the continuous development of liquid crystal technology, the requirement for the internal components of a liquid crystal display (LCD) is higher and higher.

Referring now to FIG. 1, a structural schematic view of a backlight module in a traditional technology is illustrated in FIG. 1.

A backlight module comprises a light source 11 and a light guide plate 12, wherein the light guide plate 12 comprises a light in surface 121 and a light out surface 122. A lights emitted from the light source 11 are through the light in surface 121 of the light guide plate 12 entering into the light guide plate 12, and are emitted out of the light out surface 122 of the light guide plate 12 by reflecting of the light guide plate 12.

To prevent the lights from producing a total internal reflection when they are through the light out surface 122, the traditional technology is generally provided with a plurality of micro structures 123 on the light out surface 122 of the light guide plate 12, and the micro structures 123 can prevent the lights from producing a total internal reflection on the light out surface 122.

Referring now to FIG. 2, a side view of the backlight module in FIG. 1 is illustrated in FIG. 2.

A Light in direction “A” is along a direction which is from the light source 11 and perpendicularly enters into the light guide plate 12. Along the Light in direction “A”, and with the increasing of distance between the micro structures 123 and the light source 11, pitches P′i between the adjoining micro structures 123 are gradually decrease, so that it can make the lights entering into the light guide plate 12 are uniformly emitted out, so as to avoid a phenomenon of “Mura”.

However, with the increasing of requirement of the LCD size, the size of the backlight module is correspondingly increased, so that it is necessary to need a light guide plate 12 with bigger size. While the size of the light guide plate 12 is increased, the transmission distances of the lights in the light guide plate 12 are increased. Along the direction “A”, the pitches P′i between the adjoining micro structures 123 are also smaller and smaller. Because the limit of manufacture technology, the pitches P′i between the adjoining micro structures 123 has a minimum value, such as 50 μm. When the pitches P′i are smaller than 50 μm, the adjoining micro structures 123 can not be smaller any more, and the adjoining micro structures 123 are only arranged by 50 μm, uniformly, so that the lights can not be uniformly emitted out, and then cause the “Mura” phenomenon.

Besides, if the pitch P′i is too small, such as smaller than the width of the micro structures 123, it will cause the interference between the micro structures 123, so as to influence the light out effect of the backlight module, and further influence the display quality of the LCD image.

As described above, how to solve the technologic problem influencing the image display effect, which is that the micro structures 123 of the light out surface 122 of the light guide plate 12 can not be smaller without limit causing the lights can not be uniformly emitted out of the light out surface 122 of the light guide plate 12, is become one of the research directions of the field of liquid crystal manufacture technologies.

### SUMMARY OF THE INVENTION

One of the objects of the present invention is to provide a backlight module to solve the technology problem influencing the image display effect, which is that the micro structures of the light out surface of the light guide plate can not be smaller without limit causing the lights can not be uniformly emitted out of the light out surface of the light guide plate.

For solving the above-mentioned technology problem, the present invention is provided with a backlight module, which comprises at least one light source and a light guide plate, wherein the light guide plate comprises a light out surface and a light in surface disposed on at least one side of the light out surface; the light source is closer to the light in surface, and the light out surface is provided with a plurality of strip-shaped micro structures;

wherein a light in direction is a direction which is perpendicular with the light in surface; a longitude direction of the micro structures is parallel with a horizontal plane of the light out surface of the light guide plate, and is perpendicular with the light in direction; each of the micro structures comprises a first light out surface and a second light out surface, which extend along the longitude direction and correspondingly incline to each other; the first light out surface has a first oblique angle with a horizontal plane of the light guide plate; the second light out surface has a second oblique angle with the horizontal plane of the light guide plate; and the oblique direction of the first oblique angle and the second oblique angle are opposite to each other; and

wherein with the distance increasing along the light in direction, the first oblique angle gradually decreases to a first low value, and then gradually increases to a first high value, so that the lights can be uniformly emitted out through the micro structures; and the first oblique angle is smaller than 25 degree.

In the backlight module of the present invention, with the distance increasing along the light in direction, the second oblique angle is gradually increases to a second high value, and then gradually decreases to a second low value.

In the backlight module of the present invention, the micro structures has a protrude height from the horizontal plane of the light guide plate; the protrude height of the micro structures has a variation trend as shown in follows: along the perpendicular direction, the height of the micro structures gradually increases to a first high value, and then gradually decreases to a first low value.

In the backlight module of the present invention, along the light in direction and with increasing of distance from the light source, the first oblique angles are changed, but the second oblique angles are fixed.

In the backlight module of the present invention, the first oblique angle is smaller than 25 degree.

Another one of the objects of the present invention is to provide a backlight module to solve the technology problem influencing the image display effect, which is the micro structures of the light out surface of the light guide plate can not be smaller without limit causing the light can not be uniformly emitted out of the light out surface of the light guide plate.

For solving the above-mentioned technology problem, the present invention is provided with a backlight module, which comprises at least one light source and a light guide plate, wherein the light guide plate comprises a light out surface and a light in surface disposed on at least one side of the light out surface; the light source is closer to the light in surface, and the light out surface is provided with a plurality of strip-shaped micro structures;

wherein a light in direction is a direction which is perpendicular with the light in surface; a longitude direction of the micro structures is parallel with a horizontal plane of the light out surface of the light guide plate, and is perpendicular with the light in direction; each of the micro structures comprises a first light out surface and a second light out surface, which extend along the longitude direction and correspondingly incline to each other; the first light out surface has a first oblique angle with a horizontal plane of the light guide plate; the second light out surface has a second oblique angle with the horizontal plane of the light guide plate; and the oblique direction of the first oblique angle and the second oblique angle are opposite to each other; and

wherein along the light in direction, one of the first oblique angle or the second oblique angle is changed with the distance increasing of the light source, so that the lights can be uniformly emitted out through the micro structures.

In the backlight module of the present invention, with the distance increasing along the light in direction, the first oblique angle is gradually decreases to a first low value, and then gradually increases to a first high value; and the second oblique angle is gradually increases to a second high value, and then gradually decreases to a second low value.

In the backlight module of the present invention, the micro structures has a protrude height from the horizontal plane of the light guide plate; the protrude height of the micro structures has a variation trend as shown in follows: along the perpendicular direction, the height of the micro structures gradually increases to a first high value, and then gradually decreases to a first low value.

In the backlight module of the present invention, along the light in direction and with increasing of distance from the light source, the first oblique angles are changed, but the second oblique angles are fixed.

In the backlight module of the present invention, along the light in direction and with increasing of distance from the light source, the second oblique angles are changed, but the first oblique angles are fixed.

In the backlight module of the present invention, the first oblique angle and the second oblique angle are both smaller than 25 degree.

Further, another one of the objects of the present invention is to provide a liquid crystal display (LCD) to solve the technology problem influencing the image display effect, which is the micro structures of the light out surface of the light guide plate can not be smaller without limit causing the light can not be uniformly emitted out of the light out surface of the light guide plate.

For solving the above-mentioned technology problem, the present invention is provided with an LCD comprising a backlight module, wherein the backlight module comprises at least one light source and a light guide plate; the light guide plate comprises a light out surface and a light in surface disposed on at least one side of the light out surface; the light source is closer to the light in surface, and the light out surface is provided with a plurality of strip-shaped micro structures;

wherein a light in direction is a direction which is perpendicular with the light in surface; a longitude direction of the micro structures is parallel with a horizontal plane of the light out surface of the light guide plate, and is perpendicular with the light in direction; each of the micro structures comprises a first light out surface and a second light out surface, which extend along the longitude direction and correspondingly incline to each other; the first light out surface has a first oblique angle with a horizontal plane of the light guide plate; the second light out surface has a second oblique angle with the horizontal plane of the light guide plate; and the oblique direction of the first oblique angle and the second oblique angle are opposite to each other; and

wherein along the light in direction, one of the first oblique angle or the second oblique angle is changed with the distance increasing of the light source, so that the lights can be uniformly emitted out through the micro structures.

In the LCD of the present invention, with the distance increasing along the light in direction, the first oblique angle is gradually decreases to a first low value, and then gradually increases to a first high value; and the second oblique angle is gradually increases to a second high value, and then gradually decreases to a second low value.

In the LCD of the present invention, the micro structures has a protrude height from the horizontal plane of the light guide plate; the protrude height of the micro structures has a variation trend as shown in follows: along the perpendicular direction, the height of the micro structures gradually increases to a first high value, and then gradually decreases to a first low value.

In the LCD of the present invention, along the light in direction and with increasing of distance from the light source, the first oblique angles are changed, but the second oblique angles are fixed.

In the LCD of the present invention, along the light in direction and with increasing of distance from the light source, the second oblique angles are changed, but the first oblique angles are fixed.

In the LCD of the present invention, the first oblique angle and the second oblique angle are both smaller than 25 degree.

In comparison with the traditional technologies, in the present invention, by fixed the width and pitch of the micro structure, along the light in direction which is perpendicular with light in surface and according to the different distance from the light source, it can changes at least one of the first oblique angle and second oblique angle, so that the lights can be uniformly emitted out of the light out surface. It is unnecessary to change the pitch of the micro structures, and can make the lights are uniformly emitted out of the light out surface, so as to increase the display quality of image.

For above-mention contents of the present invention can be best understood by referring to the following detailed description of the preferred embodiments and the accompanying drawings.

### DESCRIPTION OF THE DRAWINGS

FIG. 1 is a structural schematic view of a backlight module in a traditional technology;

FIG. 2 is a side view of the backlight module in FIG. 1;

FIG. 3 is a structural schematic view of a backlight module of a first preferred embodiment according to the present invention;

FIG. 4 is a side view of the light guide plate in FIG. 3;

FIG. 5 is a variation trend schematic view of the first oblique angle of the micro structures;

FIG. 6 is a variation trend schematic view of the second oblique angle of the micro structures; and

FIG. 7 is a variation trend schematic view of the protrude height of the micro structures.

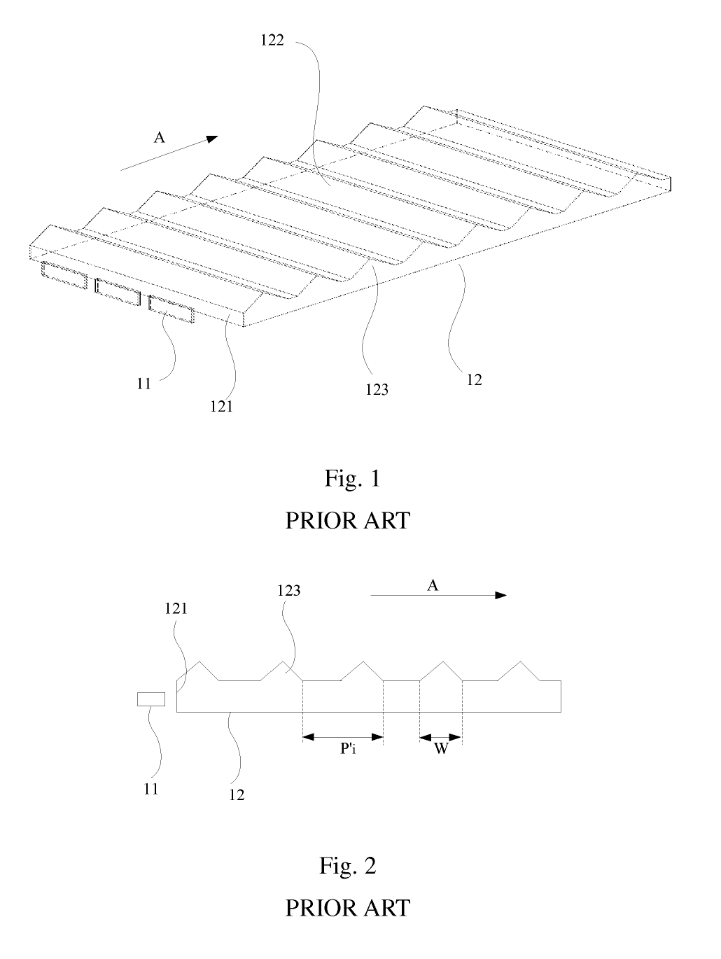

### DETAILED DESCRIPTION OF THE PREFERRED EMBODIMENTS

The description of the preferred embodiments refers to the drawings, so as to illustrate the specific embodiments of the present invention which can be carried out.

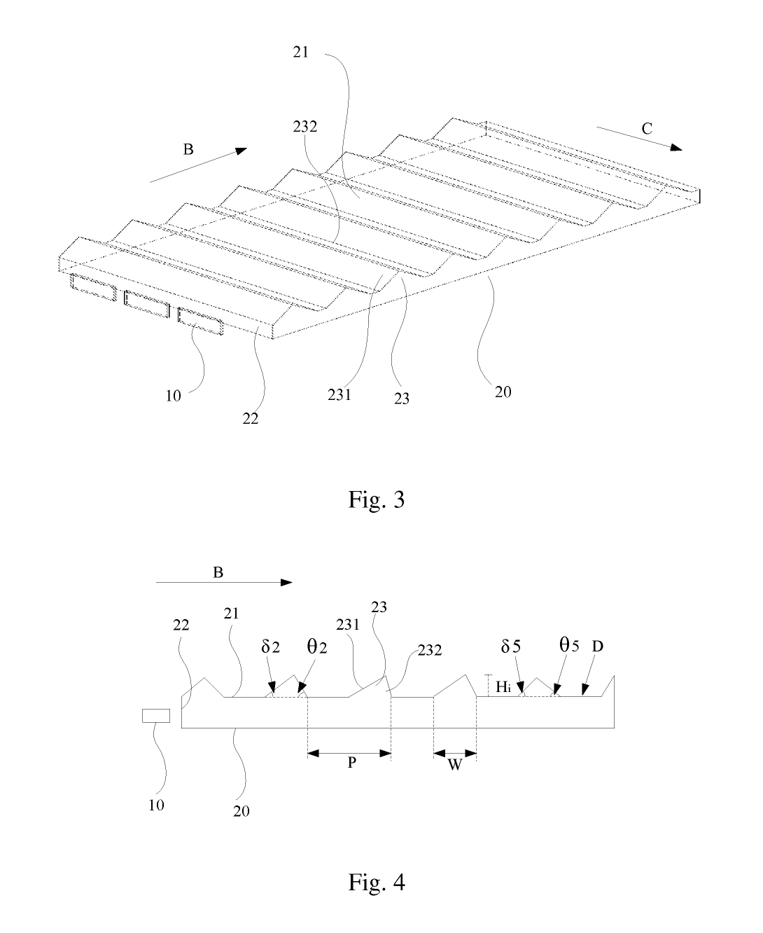

Referring now to FIG. 3, a structural schematic view of a backlight module of a first preferred embodiment according to the present invention is illustrated in FIG. 3.

A backlight module comprises at least one light source 10 and a light guide plate 20, wherein the light guide plate 20 comprises a light out surface 21 and a light in surface 22 disposed on at least one side of the light out surface 21, and the light source 10 is closer to the light in surface 22. While the embodiment is in operation, the lights emitted from the light source 10 are through the light in surface 22 entering into the light guide plate 20, and are emitted out of the light out surface 21 by reflecting of the light guide plate 20.

Referring to FIG. 4, a side view of the light guide plate in FIG. 3 is illustrated in FIG. 4.

The light out surface 21 is provided with a plurality of strip-shaped micro structures 23, wherein the micro structures 23 have the same pitches therebetween and the same widths W.

A light in direction “B” is a direction which is perpendicular with the light in surface 22. A longitude direction “C” of the micro structures 23 is parallel with a horizontal plane “D” of the light out surface 21 of the light guide plate 20, and is perpendicular with the light in direction “B”. Besides, each of the micro structures 23 extends along the longitude direction “C”, and has corresponding inclined planes.

The micro structure 23 comprises a first light out surface 231 and a second light out surface 232. There is a first oblique angle δi between Each of the first light out surface 231 of the micro structures 23 and the horizontal plane “D” of the light guide plate 20 (i is a natural number); and there is a second oblique angle θi between Each of the second light out surface 232 of the micro structures 23 and the horizontal plane “D” of the light guide plate 20 (i is a natural number). For example, along the light in direction “B”, one of the micro structures 23, which is the closest one to the light source 10 has a first oblique angle δ1 and a second oblique angle θ1; the next micro structure 23 has a first oblique angle δ2 and a second oblique angle θ2; and then the others are by analogy.

The oblique direction of the first oblique angle δi and the second oblique angle θi are opposite to each other. Specifically speaking, the first oblique angle δi is rotated in clockwise direction, and the second oblique angle θi is rotated in counter clockwise direction.

In this embodiment, along the light in direction “B”, at least one of the first oblique angle δi and the second oblique angle θi is changed with the distance increasing from the light source 10, so that the lights can be uniformly emitted out through the micro structures 23.

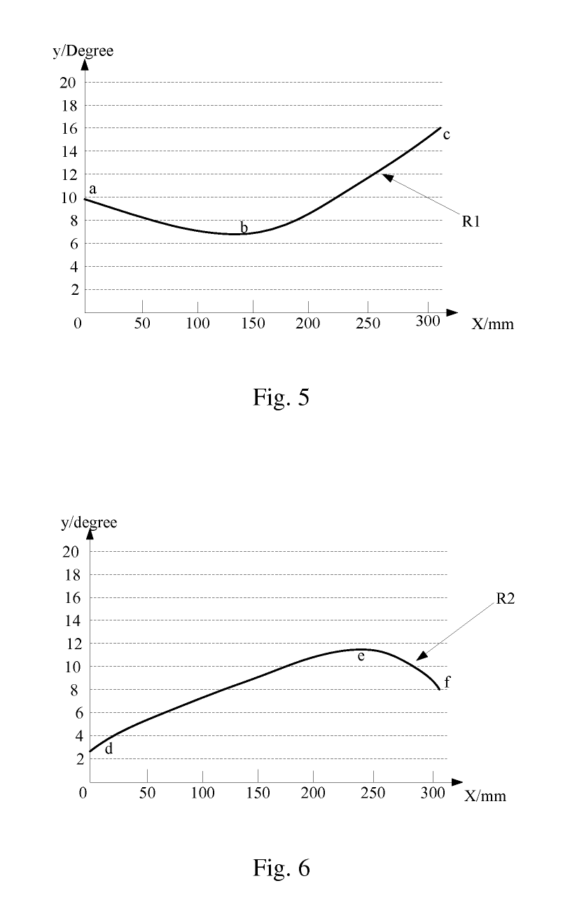

For example, please refer FIGS. 5 and 6.

FIG. 5 is a variation trend schematic view of the first oblique angle δi of the micro structures 23 along the light in direction “B”, wherein X-axis means the distance from the light source 10, and the Y-axis means the first oblique angle δi. With the distance increasing along the light in direction “B”, the value of the first oblique angle δi is from a first start point value “a” gradually decreases to a first low value “b”, and then gradually increases to a first high value “c”. For example, the first oblique angle δ2 is larger than the first oblique angle δ1; and the first oblique angle δ5 is larger than the first oblique angle δ2.

A variation relation equation of the first oblique angle δi is as follow:

δ(x)=3.8621343+1.6164448·x+5.0190765·x2+1.3845206·x3

(in this equation, X means the distance from the light source 10)

FIG. 6 is a variation trend schematic view of the second oblique angle θi of the micro structures 23 along the light in direction “B”, wherein X-axis means the distance from the light source 10, and the Y-axis means the second oblique angle θi. A variation relation equation of the second oblique angle θi is as follow:

θ(x)=10.021987+4.9999959·x−4.807639·x2−2.6291689·x3;

(in this equation, X means the distance from the light source 10)

With the distance increasing along the light in direction “B”, the value of the second oblique angle θi is from second start point value “d” gradually increases to a second high value “e”, and then gradually decreases to a second low value “f”. For example, the second oblique angle θ2 is larger than the second oblique angle θ1; and the second oblique angle θ5 is larger than the second oblique angle θ2.

While the embodiment is in operation, the first oblique angle δi and the second oblique angle θi are both smaller than 25 degree.

Referring to FIG. 4, the micro structure 23 has a protrude height Hi from the horizontal plane “D” of the light guide plate 20. For example, one of the micro structures 23 which is the closest one to the light source 10 has a protrude height H1; the next one has a protrude height H2; and then the others are by analogy.

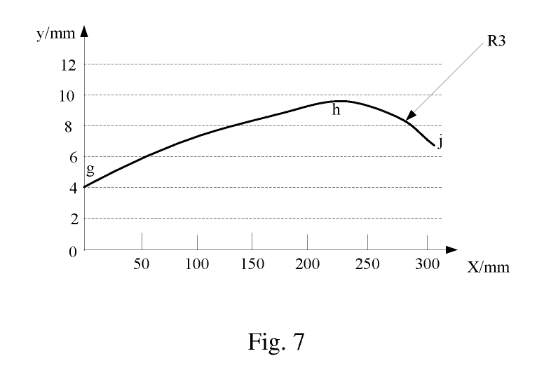

Referring to FIG. 7, FIG. 7 is a variation trend schematic view of the protrude height of the micro structures 23 along the light in direction “B”. The protrude height Hi of the micro structures 23 has a variation trend as shown in follows: along the light in direction “B”, the value of the protrude height Hi of the micro structures 23 is from a third start point value “g” gradually increases to a first high value “h”, and then gradually decreases to a first low value “j”. Certainly, the variation trend of the protrude height Hi of the micro structures 23 is base on the fixed pitches between the micro structures 23.

The pitch P between the micro structures 23 and the width of the micro structures 23 are fixed; the first oblique angle θi of the micro structures 23 have a variation trend as shown in FIG. 5; and the second oblique angle δi of the micro structures 23 have a variation trend as shown in FIG. 6. Hence, the protrude height Hi of the micro structures 23 has a variation trend as shown in FIG. 7. Because the protrude heights Hi of the micro structures 23 according to the present invention have a variation trend as shown in FIG. 6, the heights of the entire micro structures 23 of the light guide plate 20 are lower, so as to decrease the entire thickness of light guide plate 20, so that it can decrease the used quantity of material, and lower the manufacture cost.

As shown in FIGS. 3 to 7, the working principle of the first preferred embodiment of the backlight module is described as follow:

For example, the pitch P of the micro structures 23 is 150 mm, and the width W thereof is 50 mm. The first oblique angle ei of the micro structures 23 have a variation trend as shown in FIG. 4; and the second oblique angle δi of the micro structures 23 have a variation trend as shown in FIG. 5.

In the above-mentioned variation trends, along the light in direction “B”, the lights enter into the light guide plate 20, and are emitted out of the light out surface 21 by the reflecting of the light guide plate 20. Besides, along the light in direction “B”, the light-near-end portion of the light out surface 21 which is closer to the light source 10 gets the more illumination by the deflection light of the light source 10, and then it is decreased by the increasing of the distance. Hence, the value of the first oblique angle ei is from first start point value “a” gradually decreases to a first low value “b”.

In the light-far-end portion of the light out surface 21 which is the farther from the light source 10 is influenced by the reflection of the end of the light guide plate 20, so it can gets the more illumination by the deflection light of the light source 10, so that the value of the first oblique angle θi is from first low value “b” gradually increases to a first high value “c”. By above-mentioned arrangement, it makes the first light out surfaces 231 can get and reflect the lights, so that the lights can be uniformly emitted out of the light out surface 21.

The second light out surface 232 and the second oblique angle δi have the similar principle, so do not describe again.

As a second preferred embodiment of the present invention, the second oblique angle δi is a fixed value, and then along the light in direction “B” and with increasing of distance from the light source 10, the first oblique angles θi are changed, so that the lights can be uniformly emitted out of the light out surface 21.

As a third preferred embodiment of the present invention, the first oblique angle θi is a fixed value, and then along the light in direction “B” and with increasing of distance from the light source 10, the second oblique angles δi are changed, so that the lights can be uniformly emitted out of the light out surface 21.

The working principles of the second and third preferred embodiment are similar to the first preferred embodiment, so do not describe again.

The present invention also provides a liquid crystal display (LCD), the LCD comprises the backlight module of the present invention. According to the detail description in above text, so do not describe again.

In the present invention, by fixed the width and pitch of the micro structure, along the light in direction which is perpendicular with light in surface and according to the different distance from the light source, it can changes at least one of the first oblique angle and second oblique angle, so that the lights can be uniformly emitted out of the light out surface. It is unnecessary to change the pitch of the micro structures, and can make the lights are uniformly emitted out of the light out surface, so as to increase the display quality of image.

As described above, the present invention has been described with a preferred embodiment thereof and it is understood that many changes and modifications to the described embodiment can be carried out without departing from the scope and the spirit of the invention that is intended to be limited only by the appended claims.

1. A backlight module, comprising: at least one light source and a light guide plate, wherein the light guide plate comprises a light out surface and a light in surface disposed on at least one side of the light out surface; the light source is closer to the light in surface, and the light out surface is provided with a plurality of strip-shaped micro structures;
wherein a light in direction is a direction which is perpendicular with the light in surface; a longitude direction of the micro structures is parallel with a horizontal plane of the light out surface of the light guide plate, and is perpendicular with the light in direction; each of the micro structures comprises a first light out surface and a second light out surface, which extend along the longitude direction and correspondingly incline to each other; the first light out surface has a first oblique angle with a horizontal plane of the light guide plate; the second light out surface has a second oblique angle with the horizontal plane of the light guide plate; and the oblique direction of the first oblique angle and the second oblique angle are opposite to each other; and
wherein with the distance increasing along the light in direction, the first oblique angle gradually decreases to a first low value, and then gradually increases to a first high value, so that the lights are uniformly emitted out through the micro structures; and the first oblique angle is smaller than 25 degree.

2. The backlight module according to claim 1, wherein with the distance increasing along the light in direction, the second oblique angle is gradually increases to a second high value, and then gradually decreases to a second low value.

3. The backlight module according to claim 2, wherein the micro structures has a protrude height from the horizontal plane of the light guide plate; the protrude height of the micro structures has a variation trend as shown in follows: along the perpendicular direction, the height of the micro structures gradually increases to a first high value, and then gradually decreases to a first low value.

4. The backlight module according to claim 1, wherein along the light in direction and with increasing of distance from the light source, the first oblique angles are changed, but the second oblique angles are fixed.

5. The backlight module according to claim 1, wherein the first oblique angle is smaller than 25 degree.

6. A backlight module, comprising: at least one light source and a light guide plate, wherein the light guide plate comprises a light out surface and a light in surface disposed on at least one side of the light out surface; the light source is closer to the light in surface, and the light out surface is provided with a plurality of strip-shaped micro structures;
wherein a light in direction is a direction which is perpendicular with the light in surface; a longitude direction of the micro structures is parallel with a horizontal plane of the light out surface of the light guide plate, and is perpendicular with the light in direction; each of the micro structures comprises a first light out surface and a second light out surface, which extend along the longitude direction and correspondingly incline to each other; the first light out surface has a first oblique angle with a horizontal plane of the light guide plate; the second light out surface has a second oblique angle with the horizontal plane of the light guide plate; and the oblique direction of the first oblique angle and the second oblique angle are opposite to each other; and
wherein along the light in direction, one of the first oblique angle or the second oblique angle is changed with the distance increasing of the light source, so that the lights are uniformly emitted out through the micro structures.

7. The backlight module according to claim 6, wherein with the distance increasing along the light in direction, the first oblique angle is gradually decreases to a first low value, and then gradually increases to a first high value; and the second oblique angle is gradually increases to a second high value, and then gradually decreases to a second low value.

8. The backlight module according to claim 7, wherein the micro structures has a protrude height from the horizontal plane of the light guide plate; the protrude height of the micro structures has a variation trend as shown in follows: along the perpendicular direction, the height of the micro structures gradually increases to a first high value, and then gradually decreases to a first low value.

9. The backlight module according to claim 6, wherein along the light in direction and with increasing of distance from the light source, the first oblique angles are changed, but the second oblique angles are fixed.

10. The backlight module according to claim 6, wherein along the light in direction and with increasing of distance from the light source, the second oblique angles are changed, but the first oblique angles are fixed.

11. The backlight module according to claim 6, wherein the first oblique angle and the second oblique angle are both smaller than 25 degree.

12. A liquid crystal display (LCD), comprising: a backlight module, which comprises at least one light source and a light guide plate, wherein the light guide plate comprises a light out surface and a light in surface disposed on at least one side of the light out surface; the light source is closer to the light in surface, and the light out surface is provided with a plurality of strip-shaped micro structures;
wherein a light in direction is a direction which is perpendicular with the light in surface; a longitude direction of the micro structures is parallel with a horizontal plane of the light out surface of the light guide plate, and is perpendicular with the light in direction; each of the micro structures comprises a first light out surface and a second light out surface, which extend along the longitude direction and correspondingly incline to each other; the first light out surface has a first oblique angle with a horizontal plane of the light guide plate; the second light out surface has a second oblique angle with the horizontal plane of the light guide plate; and the oblique direction of the first oblique angle and the second oblique angle are opposite to each other; and
wherein along the light in direction, one of the first oblique angle or the second oblique angle is changed with the distance increasing of the light source, so that the lights are uniformly emitted out through the micro structures.

13. The LCD according to claim 12, wherein with the distance increasing along the light in direction, the first oblique angle is gradually decreases to a first low value, and then gradually increases to a first high value; and the second oblique angle is gradually increases to a second high value, and then gradually decreases to a second low value.

14. The LCD according to claim 13, wherein the micro structures has a protrude height from the horizontal plane of the light guide plate; the protrude height of the micro structures has a variation trend as shown in follows: along the perpendicular direction, the height of the micro structures gradually increases to a first high value, and then gradually decreases to a first low value.

15. The LCD according to claim 12, wherein along the light in direction and with increasing of distance from the light source, the first oblique angles are changed, but the second oblique angles are fixed.

16. The LCD according to claim 12, wherein along the light in direction and with increasing of distance from the light source, the second oblique angles are changed, but the first oblique angles are fixed.

17. The LCD according to claim 12, wherein the first oblique angle and the second oblique angle are both smaller than 25 degree.
